(19) United States
(12) Patent Application Publication
(10) Pub. No.: US 2009/0167674 A1
(43) Pub. Date: Jul. 2, 2009

(54) Light source system and display

(75) Inventor: Yoshihiro Katsu, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/292,367

(22) Filed: Nov. 18, 2008

(30) Foreign Application Priority Data
Dec. 28, 2007 (JP) 2007-340962

(51) Int. Cl. G09G 3/36

(52) U.S. Cl. 345/102

(57) ABSTRACT

A light source system includes: a light source having a plurality of lighting sections each including one or more light-emitting diodes and controllable independently of one another; a light-sensing device detecting light from the light source in which the lighting sections are allowed to illuminate independently of one another; and a light source control means for controlling the light source by changing at least light emission intensity of each lighting section on the basis of a detected light amount, wherein the light source control means adjusts light emission currents in each lighting section in consideration of variation, among the plurality of lighting sections, in light emission characteristics showing a relationship between light emission currents flowing through the light-emitting diodes in a lighting section that illuminates and the detected light amount, thereby the light source control means controls the light emission intensity of each lighting section.

### CROSS REFERENCES TO RELATED APPLICATIONS

The present invention contains subject matter related to Japanese Patent Application JP 2007-340962 filed in the Japanese Patent Office on Dec. 28, 2007, the entire contents of which being incorporated herein by reference.

### BACKGROUND OF THE INVENTION

1. Field of the Invention

The present invention relates to a light source system used as, for example, a backlight source of a liquid crystal display, and a display using the light source system.

2. Description of the Related Art

In recent years, flat panel displays as typified by liquid crystal TVs and plasma display panels (PDPs) have become a trend, and among them, most of mobile displays are liquid crystal displays, and precise color reproducibility is desired in the mobile displays. Moreover, as backlights for liquid crystal panels, CCFLs (Cold Cathode Fluorescent Lamps) using fluorescent tubes are mainstream; however, mercury-free light sources are environmentally desired, so light emitting diodes (LEDs) and the like hold promise as light sources replacing CCFLs.

As such a backlight system using an LED, for example, techniques described in Japanese Unexamined Patent Application Publication Nos. 2001-142409 and 2005-302737 have been proposed. An LED backlight system shown in Japanese Unexamined Patent Application Publication No. 2001-142409 includes a plurality of separate lighting sections, and carries out lighting operation of each of the lighting sections independently. On the other hand, an LED backlight system shown in Japanese Unexamined Patent Application Publication No. 2005-302737 detects illumination light from a light source by a light-sensing device, and controls the light emission amount of the light source on the basis of a detection value obtained by detecting the illumination light.

### SUMMARY OF THE INVENTION

In an LED backlight system in which lighting sections are allowed to illuminate independently of one another shown in Japanese Unexamined Patent Application Publication No. 2001-142409, each lighting section has different light emission intensity and a different lighting duration, so each lighting section has a different degree of change in light emission characteristics with a lapse of time. Therefore, in this state, variation in light emission amount (light emission intensity) among the lighting sections occurs with time, thereby in a display image, unevenness in luminance, chromaticity or the like may occur.

Therefore, it is considered that in such an LED backlight system in which the lighting sections are allowed to illuminate independently of one another, a plurality of light-sensing devices shown in Japanese Unexamined Patent Application Publication No. 2005-302737 are arranged corresponding to the lighting sections, respectively, and the light emission amount of each lighting section is controlled on the basis of the detection value of illumination light detected by the light-sensing device. It is because in such a configuration, even if the degree of change in light emission characteristics with a lapse of time is different among the lighting sections, variation in light emission amount among the lighting sections is able to be reduced by controlling the light emission amount of each lighting section.

However, in different lighting sections, even if the same light emission current flows through the lighting sections, the actual light emission amounts of the lighting sections may be different from one another because of variation in light emission characteristics of LEDs included in the lighting sections. Therefore, variation in light emission amount among the lighting sections is increased, thereby there is an issue such as variation in convergence rate in light emission feedback operation through the use of the light-sensing device.

Thus, in techniques in related arts, in the case where a plurality of lighting sections are used to perform partial lighting operation, it is difficult to reduce variation in light emission amount among the lighting sections or variation in convergence characteristics (variation in characteristics) in feedback operation, and there is room for improvement.

In view of the foregoing, it is desirable to provide a light source system capable of reducing variation in characteristics among lighting sections in the case where partial lighting operation is performed and a display using the light source system.

According to an embodiment of the invention, there is provided a light source system including: a light source having a plurality of lighting sections each including one or more light-emitting diodes and being controllable independently of one another; a light-sensing device detecting light from the light source in which the lighting sections are allowed to illuminate independently of one another; and a light source control means for controlling the light source by changing at least light emission intensity of each lighting section on the basis of a light amount detected by the light-sensing device for each lighting section. In this case, the light source control means adjusts light emission currents in each lighting section in consideration of variation, among the plurality of lighting sections, in light emission characteristics showing a relationship between light emission currents flowing through the light-emitting diodes in a lighting section that illuminates and the light amount detected by the light-sensing device for the corresponding lighting section, thereby the light source control means controls the light emission intensity of each lighting section.

According to an embodiment of the invention, there is provided a display including: a light source system having the above-described configuration, and a display section modulating light emitted from the light source system on the basis of an image signal.

In addition, any arbitrary combination of the aforementioned constituent elements and the expression of the present invention changed among a system, an apparatus, a method, and so forth are also effective as the embodiment of the invention.

In the light source system according to the embodiment of the invention, light from the light source in which the lighting sections are allowed to illuminate independently of one another is detected by the light-sensing device, and the light source is controlled by changing at least light emission intensity of each lighting section on the basis of the light amount detected by the light-sensing device for each lighting section. Moreover, the light emission currents in each lighting section are adjusted in consideration of variation in the above-described light emission characteristics among the plurality of lighting sections, thereby the light emission intensity of each lighting section is controlled. Thereby, even if variation among the lighting sections occurs, variation in light emission intensity among the lighting sections is reduced.

In the light source system and the display according to the embodiment of the invention, the light emission intensity of each lighting section is controlled by adjusting the light emission currents in each lighting section in consideration of variation among the plurality of lighting sections in the light emission characteristics showing a relationship between the light emission currents in a lighting section that illuminates and the detected light amount for the corresponding lighting section, so even if variation among the lighting sections occurs, variation in light emission intensity among the lighting sections is able to be reduced. Therefore, in the case where partial lighting operation is performed, variation in characteristics among the lighting sections is able to be reduced.

Other and further objects, features and advantages of the invention will appear more fully from the following description.

### BRIEF DESCRIPTION OF THE DRAWINGS

FIG. 1 is a perspective view showing the whole configuration of an image display system (a liquid crystal display) according to an embodiment of the invention;

FIGS. 2A and 2B are schematic plan views showing a configuration example of a unit (a lighting section) of a light source in a backlight system shown in FIG. 1;

FIG. 3 is a schematic plan view showing an arrangement example of the lighting section and an illumination light sensor in the light source shown in FIGS. 2A and 2B;

FIG. 4 is a block diagram showing the whole configuration of the liquid crystal display shown in FIG. 1;

FIG. 5 is a block diagram showing specific configurations of driving and control sections of the light source shown in FIG. 4;

FIG. 6 is a timing waveform chart for describing a drive pulse signal of the light source;

FIG. 7 is a timing waveform chart for describing an example of a method of driving a liquid crystal display panel and the backlight system shown in FIG. 1;

FIG. 8 is a perspective view for describing an example of an arrangement relationship between an image display region and a partial lighting region;

FIG. 9 is a plot for describing a method of controlling a light emission current according to the embodiment; and

FIG. 10 is a flow chart showing the method of controlling a light emission current according to the embodiment.

### DETAILED DESCRIPTION OF THE PREFERRED EMBODIMENTS

A preferred embodiment will be described in detail below referring to the accompanying drawings.

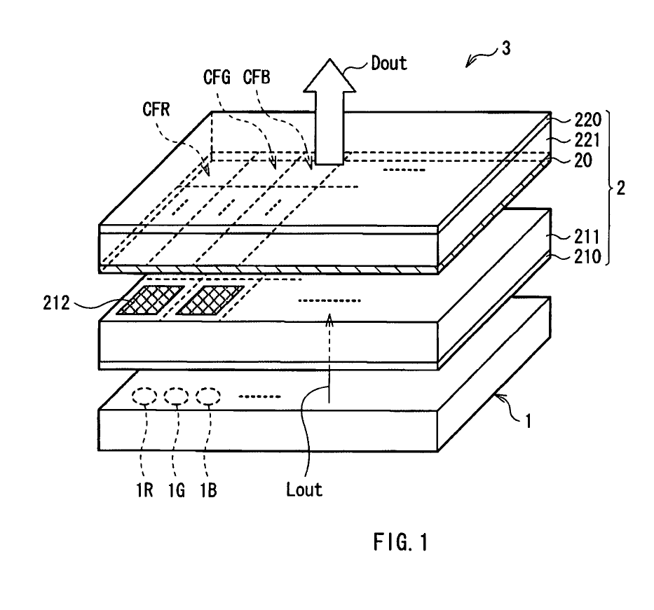

FIG. 1 shows the whole configuration of an image display system (a liquid crystal display 3) according to an embodiment of the invention. The liquid crystal display 3 is a so-called transmissive liquid crystal display emitting transmitted light as display light Dout, and includes a backlight system 1 as a light source device according to an embodiment of the invention and a transmissive liquid crystal display panel 2. A method of displaying an image according to an embodiment of the invention is embodied by an image display system according to the embodiment, and will be also described below.

The liquid crystal display panel 2 includes a transmissive liquid crystal layer 20, a pair of substrates between which the liquid crystal layer 20 is sandwiched, that is, a TFT (Thin Film Transistor) substrate 211 as a substrate on a side closer to the backlight system 1 and a facing electrode substrate 221 as a substrate facing the TFT substrate 211, and polarizing plates 210 and 220 laminated on a side of the TFT substrate 211 and a side of the facing electrode substrate 221 opposite to sides closer to the liquid crystal layer 20, respectively.

Moreover, the TFT substrate 211 includes pixels in a matrix form, and in each pixel, a pixel electrode 212 including a driving device such as a TFT is formed.

The backlight system 1 is a color mixing type backlight system detecting illumination light Lout as specific color light by mixing a plurality of color light beams (in this case, red light, green light and blue light). The backlight system 1 includes a light source (a light source 10 which will be described later) including a plurality of red LEDs 1R, a plurality of green LEDs 1G and a plurality of blue LEDs 1B as three kinds of light sources emitting different color light beams.

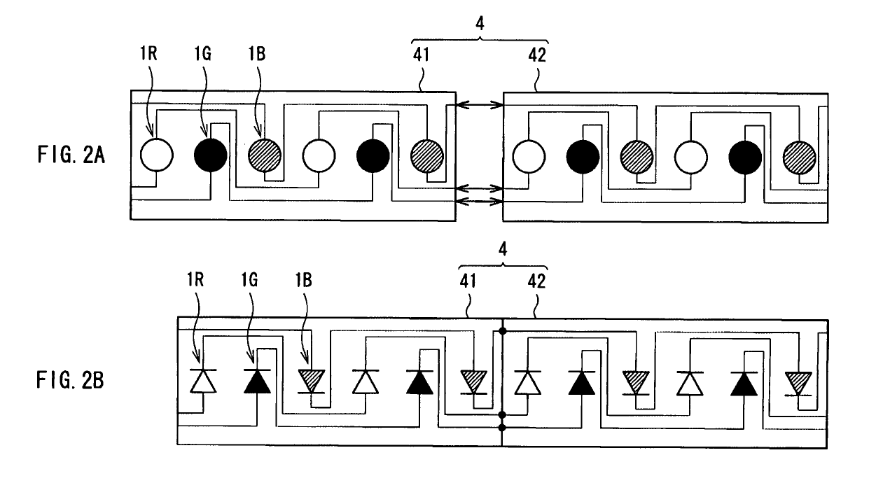

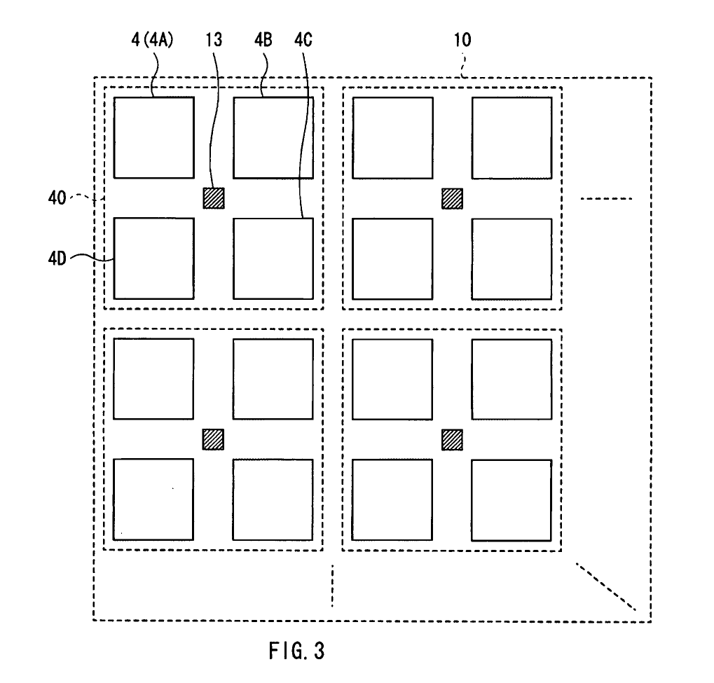

FIGS. 2A, 2B and 3 show an example of the arrangement of each LED in the backlight system 1.

As shown in FIG. 2A, in the backlight system 1, a pair of red LEDs 1R, a pair of green LEDs 1G and a pair of blue LEDs 1B constitute each of unit cells 41 and 42 in a light emitting section, and two unit cells 41 and 42 constitute a lighting section 4 as a unit of the light emitting section. Moreover, LEDs of each color are serially connected to one anther in each unit cell and between the unit cells 41 and 42. More specifically, as shown in FIG. 2B, an anode of an LED of each color is connected to a cathode of another LED of the same color.

For example, as shown in FIG. 3, the lighting sections 4 with such a configuration are arranged in a matrix form in the light source 10, and as will be described later, the lighting sections 4 are controllable independently of one another. Moreover, on the light source 10, one illumination light sensor 13 is arranged for four lighting sections 4 (for example, lighting sections 4A to 4D). Although details will be described later, the illumination light sensor 13 detects light (illumination light Lout which will be described later) from the lighting sections 4, and is able to receive light from a region (a detection region 40) corresponding to a region where four lighting sections 4 are arranged.

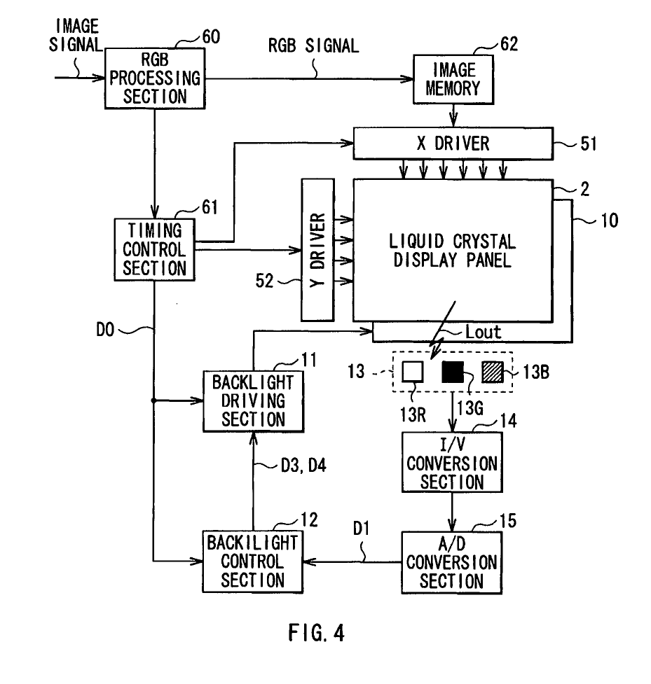

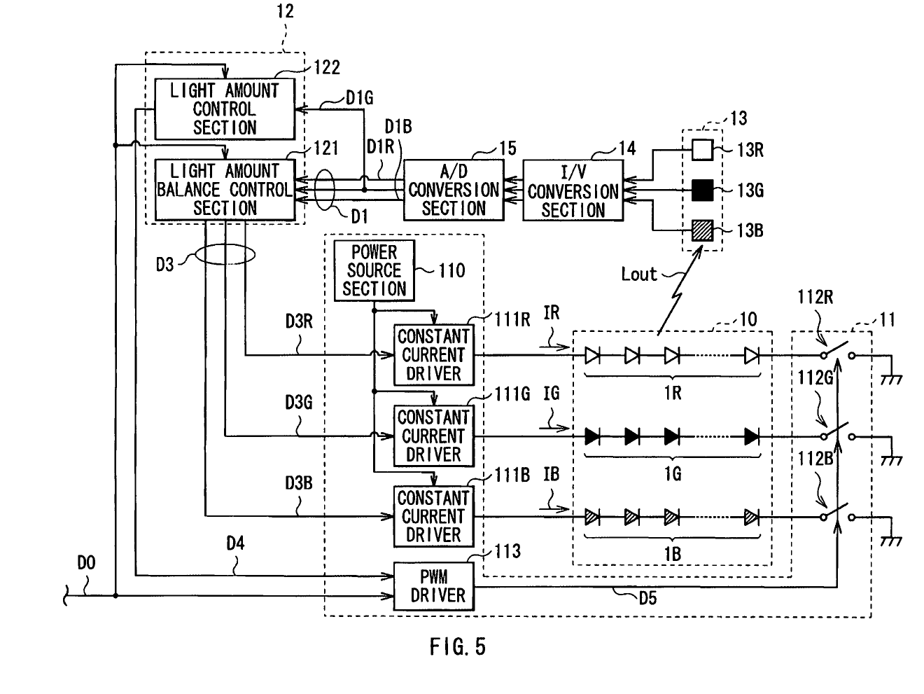

Next, referring to FIG. 4, the configurations of driving and control sections of the above-described liquid crystal display panel 2 and the above-described light source 10 will be described in detail below. FIG. 4 shows a block diagram of the liquid crystal display 3. In FIG. 4 (and FIG. 5 which will be described later), for the sake of convenience, only one illumination light sensor 13 is arranged near the light source 10.

As shown in FIG. 4, a driving circuit for displaying an image by driving the liquid crystal display panel 2 includes an X driver (data driver) 51 supplying a drive voltage on the basis of an image signal to each pixel electrode 212 in the liquid crystal display panel 2, a Y driver (gate driver) 52 line-sequentially driving the pixel electrodes 212 in the liquid crystal panel 2 along a scanning line (not shown), a timing control section (a timing generator) 61 controlling the X driver 51 and the Y driver 52, an RGB processing section (a signal generator) 60 generating an RGB signal by processing an image signal from outside, and an image memory 62 as a frame memory storing the RGB signal from the RGB processing section 60.

On the other hand, a section driving and controlling the light source 10 to perform the lighting operation of the backlight system 1 includes a backlight driving section 11, a backlight control section 12, an illumination light sensor 13, an I/V conversion section 14 and an A/D conversion section 15.

The illumination light sensor 13 obtains a light reception signal by detecting the illumination light Lout from the light source 10 (more specifically, as described above, the lighting sections 4 in each detection region 40), and includes a red light sensor 13R selectively extracting and detecting red light from mixed color light produced by mixing a plurality of color light beams (in this case, red light, green light and blue light), a green light sensor 13G selectively extracting and detecting green light from the mixed color light, and a blue light sensor 13B selectively extracting and detecting blue light from the mixed color light.

The I/V conversion section 14 performs I/V (current/voltage) conversion on a light reception signal of each color detected by the illumination light sensor 13 so as to output light reception data of each color as an analog voltage signal.

The A/D conversion section 15 samples the light reception data of each color outputted from the I/V conversion section 14 at a predetermined timing, and performs A/D (analog/digital) conversion on the light reception data of each color to output light reception data D1 of each color as a digital voltage signal to the backlight control section 12.

The backlight control section 12 generates and outputs control signals D3 and D4 which will be described later on the basis of the light reception data D1 of each color supplied from the A/D conversion section 15, and a control signal (control data) D0 supplied from the timing control section 61 so as to control the driving operation of the backlight driving section 11. The specific configuration of the backlight control section 12 will be described later (refer to FIG. 5).

The backlight driving section 11 drives the light source 10 to perform the lighting operation of each lighting section in a time division manner on the basis of the control signal D3 and D4 supplied from the backlight control section 12 and the control signal D0 supplied from the timing control section 61. The specific configuration of the backlight driving section 11 will be described later (refer to FIG. 5).

Next, referring to FIG. 5, the specific configurations of the above-described backlight driving section 11 and the backlight control section 12 will be described below. FIG. 5 shows a block diagram of the specific configurations of the backlight driving section 11 and the backlight control section 12, and the configurations of the light source 10, the illumination light sensor 13, the I/V conversion section 14 and the A/D conversion section 15. The light reception data D1 includes red light reception data D1R, green light reception data D1G and blue light reception data D1B, and the control signal D3 includes a red control signal D3R, a green control signal D3G and a blue control signal D3B, and the control signal D4 includes a red control signal D4R, a green control signal D4G and a blue control signal D4B. In this case, for the sake of convenience, the case where the red LED 1R, the green LED 1G and the blue LED 1B are serially connected to one another in the light source 10 is shown.

The backlight driving section 11 includes a power source section 110, constant current drivers 111R, 111G and 111B supplying currents IR, IG and IB to the anodes of the red LED 1R, the green LED 1G and the blue LED 1B, respectively, in the light source 10 by power supplied from the power source section 110 on the basis of the control signal D3 (the red control signal D3R, the green control signal D3G and the blue control signal D3B) supplied from the backlight control section 12, switching devices 112R, 112G and 112B connected between the cathodes of the red LED 1R, the green LED 1G and the blue LED 1B and the ground, respectively, and a PWM driver 113 generating and outputting control signals D5 (pulse signals) for the switching devices 112R, 112G and 112B on the basis of the control signal D4 supplied from the backlight control section 12 and the control signal D0 supplied from the timing control section 61 to perform PWM control on the switching devices 112R, 112G and 112B, respectively. The switching devices 112R, 112G and 112B each include, for example, s transistor such as an MOS-FET (Metal Oxide Semiconductor-Field Emission Transistor), or the like.

Further, the backlight control section 12 includes a light amount balance control section 121 and a light amount control section 122.

The light amount balance control section 121 generates and outputs the control signals D3 (the red control signal D3R, the green control signal D3G and the blue control signal D3B) for the constant-current drivers 111R, 111G and 111B on the basis of the light reception data D1 (the red light reception data D1R, the green light reception data D1G and the blue light reception data D1B) supplied from the A/D conversion section 15 and the control signal D0 supplied from the timing control section 61, thereby the light amount balance control section 121 changes currents (light emission currents) IR, IG and IB flowing through the red LED 1R, the green LED 1G and the blue LED 1B, respectively, at each color temperature to change light emission intensity of the LEDs, thereby the light amount balance control section 121 controls the color balance (the color temperature) of the illumination light Lout from the light source 10 depending on a setting value.

The light amount balance control section 121 also controls the light emission intensity of each lighting section 4 by adjusting each of light emission currents IR, IG and IB in each lighting section 4 in consideration of variation among the lighting sections 4 in the light emission characteristics (LED characteristics G1, G2 or the like which will be described later) showing a relationship between the currents IR, IG and IB (light emission currents) flowing through LEDs (the red LED 1R, the green LED 1G and the blue LED 1B) in a lighting section 4 that illuminates and the light amount (the light reception data D1, the A/D value of a light sensor) detected by the illumination light sensor 13 for the corresponding lighting section 4. More specifically, the light amount balance control section 121 controls the light emission intensities of the lighting sections 4 into a same level by adjusting the light emission currents IR, IG and IB in each lighting section 4. Such a method of controlling a light emission current will be described in detail later.

The light amount control section 122 changes the light emission durations (lighting durations) of the red LED 1R, the green LED 1R and the blue LED 1B by generating and outputting the control signal D4 for the PWM driver 113 on the basis of the green light reception data D1G of the light reception data D1 supplied from the A/D conversion section 15 and the control signal D0 supplied from the timing control section 61, thereby the light amount control section 122 controls the light emission amount (light emission intensity) of the illumination light Lout from the light source 10. In this case, only the control signal D1G of the control signals D1R, D1G and D1B is inputted, because human eyes have the highest spectral sensitivity for green light, and other control signals D1R and D1B may be inputted.

The backlight control section 12 corresponds to a specific example of “a light source control means” in the invention. The liquid crystal display panel 2 corresponds to a specific example of “a display section” in the invention. The light amount balance control section 121 and the light amount control section 122 correspond to specific examples of “a light source control means” in the invention.

Next, the operations of the backlight system 1 with such a configuration and the liquid crystal display 3 according to the embodiment will be described in detail below.

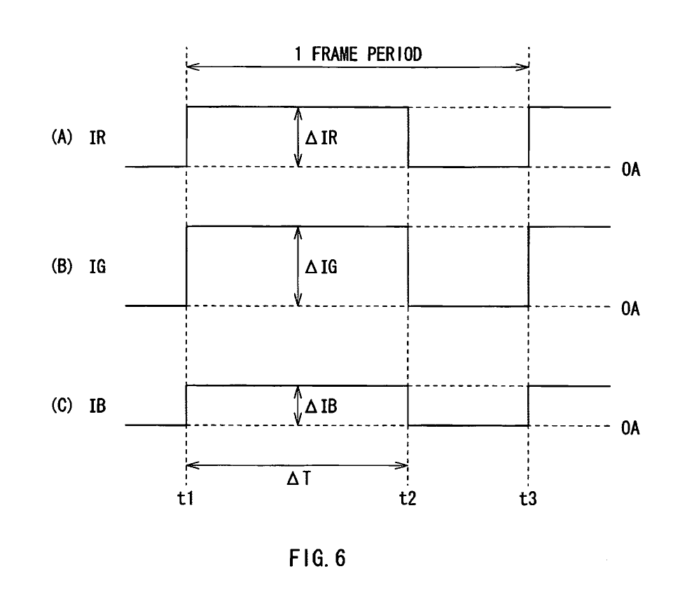

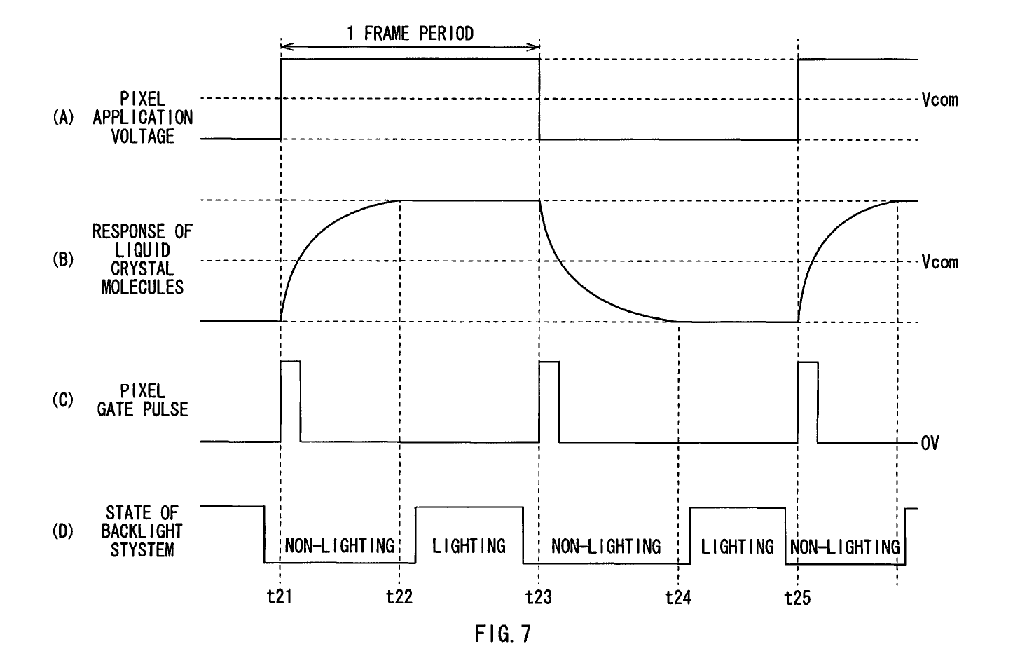

At first, referring to FIGS. 1 to 8, the basic operations of the backlight system 1 and the liquid crystal display 3 according to the embodiment will be described below. FIG. 6 shows a timing waveform chart showing the lighting operation in the light source 10 of the backlight system 1, and (A) shows a current (light emission current) IR flowing through the red LED 1R, (B) shows a current IG flowing through the green LED 1G, and (C) shows a current IB flowing through the blue LED 1B. Moreover, FIG. 7 shows a timing waveform chart briefly showing the operation of the whole liquid crystal display 3, and (A) shows a voltage (a pixel application voltage, a drive voltage) applied from the X driver 51 to each pixel electrode 212 in the liquid crystal panel 2, (B) shows the response of liquid crystal molecules (an actual potential state in the pixel electrode 212) and (C) shows a voltage (a pixel gate pulse) applied from the Y driver 52 to the gate of a TFT device in the liquid crystal panel 2.

In the backlight system 1, when the switching devices 112R, 112G and 112B in the backlight driving section 11 turns into an on state, the currents (light emission currents) IR, IG and IB flow from the constant current drivers 111R, 111G and 111B to the red LEDs 1R, the green LEDs 1G and the blue LEDs 1B in the light source 10, respectively, by power supply from the power source section 110, thereby red light, green light and blue light are emitted so as to emit the illumination light Lout as mixed color light.

At this time, the control signal D0 is supplied from the timing control section 61 to the backlight driving section 11, and the control signals D5 on the basis of the control signal D0 are supplied from the PWM driver 113 in the backlight driving section 11 to the switching devices 112R, 112G and 112B, thereby the switching devices 112R, 112G and 112B are turned into an on state at a timing in synchronization with the control signal D0, and the lighting durations of the red LEDs 1R, the green LEDs 1G and the blue LEDs 1B synchronize with the control signal D0. In other words, the red LED 1R, the green LED 1G and the blue LED 1B are PWM-driven by time-division drive using the control signals D5 as pulse signals.

Moreover, at this time, the illumination light sensor 13 detects the illumination light Lout (and the background light Lbg which will be described later) from the light source 10. More specifically, in the red light sensor 13R, the green light sensor 13G and the blue light sensor 13B in the illumination light sensor 13, a photodiode of each color extracts each color light from the illumination light Lout from the light source 10, and a current according to the light amount of each color light is generated, thereby the light reception data of the current value is supplied to the I/V conversion section 14. Further, the light reception data of the current value of each color is converted into light reception data of an analog voltage value by the I/V conversion section 14. Then, the light reception data of the analog voltage value of each color is sampled at a predetermined timing in the A/D conversion section 15, and is converted into light reception data D1R, D1G or D1B (an A/D value of a light sensor which will be described later) of a digital voltage value.

In this case, in the backlight control section 12, on the basis of the light reception data D1R, D1G and D1B for each color supplied from the A/D conversion section 15, the control signals D3R, D3G and D3B are supplied from the light amount balance control section 121 to the constant-current drivers 111R, 111G and 111B, respectively, thereby the magnitudes ΔIR, ΔIG and ΔIB of the currents IR, IG and IB, that is, the light emission intensities of the LEDs 1R, 1G and 1B are adjusted so as to keep the chromaticity (color temperature, color balance) of the illumination light Lout constant (refer to FIG. 6(A) to (C)).

Moreover, in the light amount control section 122, the control signal D4 is generated on the basis of the light reception data D1G of the light reception data D1R, D1G and D1B for each color supplied from the A/D conversion section 15, and is supplied to the PWM driver 113, thereby the on durations of the switching devices 112R, 112G and 112B, that is, the lighting durations ΔT of the LEDs 1R, 1G and 1B are adjusted (refer to FIG. 6(A) to (C)).

Thus, on the basis of the illumination light Lout from the light source 10, the magnitudes ΔIR, ΔIG and ΔIB of the currents IR, IG and IB (the light emission intensities of the LEDs 1R, 1G and 1B) and the lighting durations are controlled, thereby the light emission amount (light emission intensity) of the illumination light Lout of each lighting section 4 is controlled.

On the other hand, in the whole liquid crystal display 3 according to the embodiment, the illumination light Lout from the light source 10 of the backlight system 1 is modulated in a liquid crystal layer 20 by drive voltages (pixel application voltages) outputted from the X driver 51 and the Y driver 52 to the pixel electrodes 212 on the basis of an image signal, and the modulated illumination light Lout is outputted from the liquid crystal panel 2 as display light Dout. Thus, the backlight system 1 functions as a backlight (a light source device for liquid crystal) of the liquid crystal display 3, thereby an image is displayed by the display light Dout.

More specifically, for example, as shown in FIG. 7(C), a pixel gate pulse is applied from the Y driver 52 to the gates of the TFT devices on one horizontal line in the liquid crystal panel 2, and at the same time, as shown in FIG. 7(A), a pixel application voltage on the basis of the image signal is applied from the X driver 51 to the pixel electrodes 212 on the one horizontal line. At this time, as shown in FIG. 7(B), the response of the actual potential of the pixel electrodes 212 relative to a pixel application voltage (response of liquid crystal molecules) is delayed (while the pixel application voltage starts at a timing t21, the actual potential starts at a timing t12), and the backlight system 1 turns into a lighting state in a period from timings t22 to t23 in which the actual potential is equal to the pixel application voltage (refer to FIG. 7(D)), thereby an image on the basis of the image signal is displayed on the liquid crystal display 3. In FIG. 7, the period from the timing t21 to t23 corresponds to one horizontal period (one frame period), and in the next horizontal period from the timings t23 to t25, the same operation as that in one horizontal period from the timings t21 to t23 is performed, except that the pixel application voltage is inverted relative to a common potential Vcom to prevent burn-in on the liquid crystal display or the like.

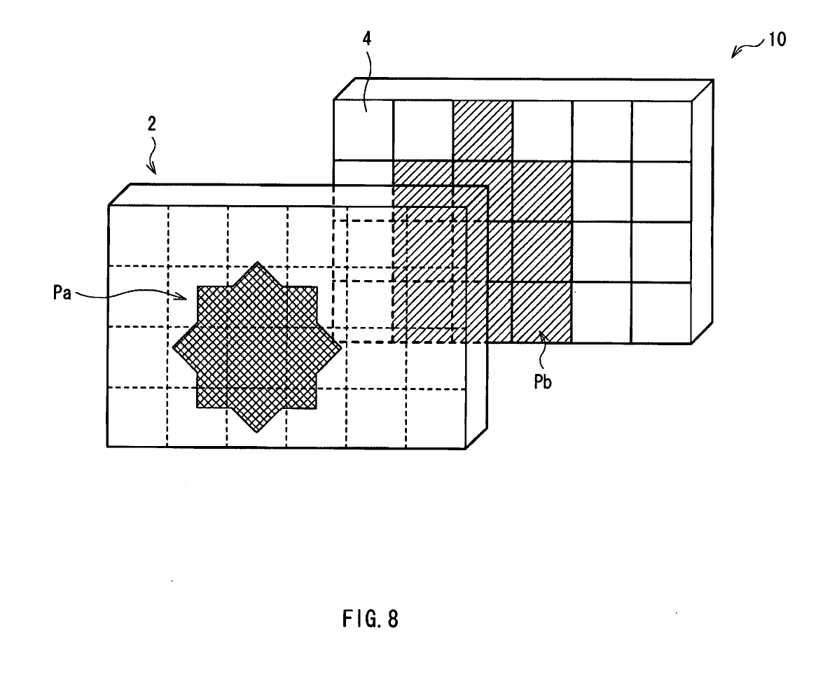

Moreover, in the liquid crystal display 3, the control signal D0 is supplied from the timing control section 61 to the PWM driver 113 in the backlight driving section 11 through the use of a signal (a signal on the basis of the image signal) supplied from the RGB processing section 60; therefore, for example, as shown in FIG. 8, in the light source 10, only lighting sections 4 in a region corresponding to an image display region (a region where an display image Pa is displayed) having a predetermined luminance or higher of an image display region in the liquid crystal display panel 2 illuminate, thereby the operation of forming a partial lighting region Pb becomes possible.

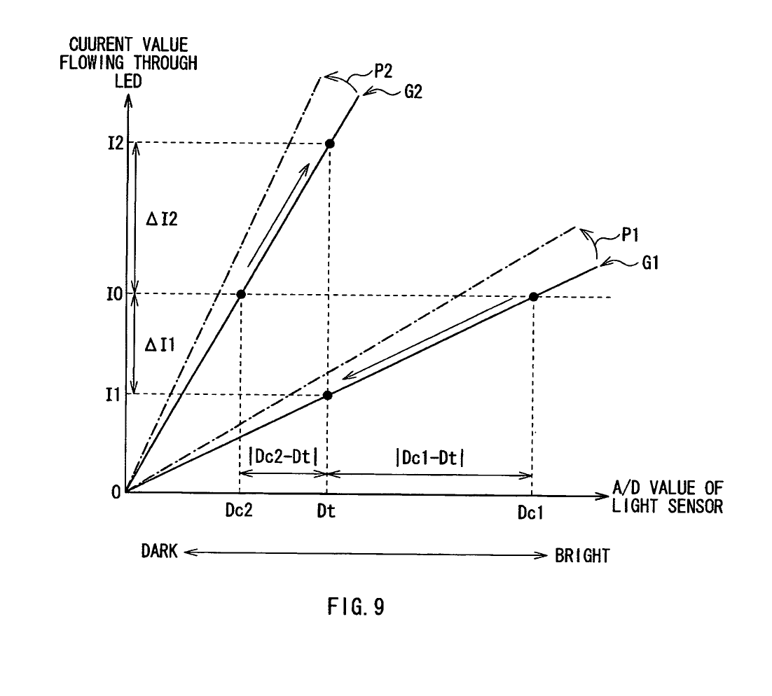

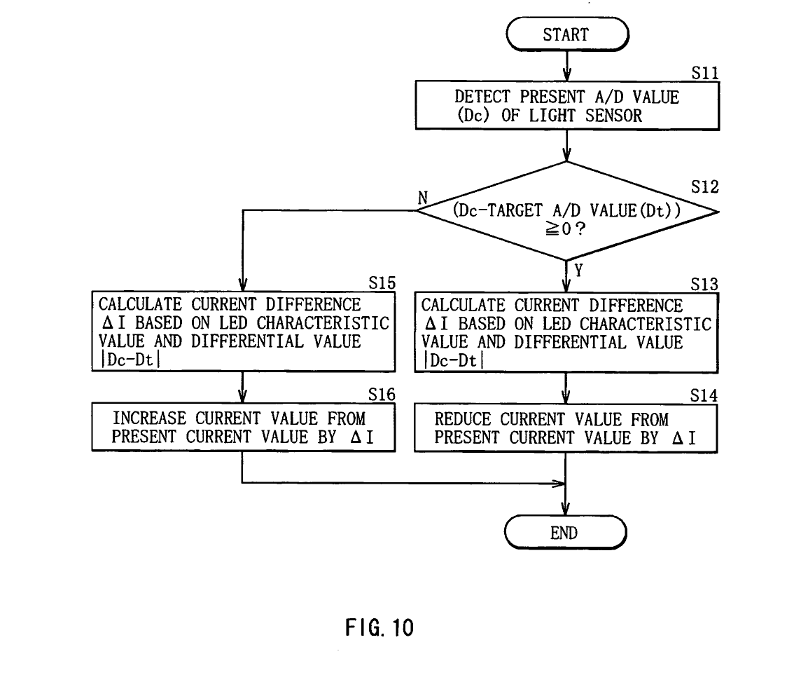

Next, referring to FIGS. 9 and 10 in addition to FIGS. 1 to 8, the control operation as a characteristic part of the embodiment of the invention will be described in detail below.

At first, for example, as shown in FIG. 9, light emission characteristics showing a relationship between the currents IR, IG and IB (light emission currents) flowing through LEDs in an illuminating lighting section 4 and the light amount (the light reception data D1, the A/D value of the light sensor) detected by the illumination light sensor 13 for the corresponding lighting section 4 are generally different among the lighting sections 4 as shown in LED characteristics G1, G2 or the like shown in the drawing, thereby variation among the lighting sections 4 occurs. Therefore, even if the same light emission current (for example, a light emission current I0 shown in the drawing) flows through each lighting section 4, the actual light emission amounts of the lighting sections 4 (that is, the A/D values of the light sensor) are different from one another as shown in A/D values Dc1 and Dc2 in the drawing. In such a case, variation in light emission amount among the lighting sections 4 is increased, thereby there is an issue such as variation in convergence rate at the time of light emission feedback operation through the use of the illumination light sensor 13.

Therefore, in the backlight system 1 according to the embodiment, the light amount balance control section 121 in the backlight control section 12 performs, for example, the adjustment of the light emission current shown in FIG. 10. In other words, the light amount balance control section 121 adjusts the light emission currents IR, IG and IB in each lighting section 4 in consideration of variation among the lighting sections 4 so as to control the light emission intensity of each lighting section 4. More specifically, the light emission intensities of the lighting sections 4 are controlled into a same level by adjusting the light emission currents IR, IG and IB in each lighting section 4.

More specifically, at first, the light amount balance control section 121 detects the present A/D value Dc in each lighting section 4 such as an A/D value (light reception data) Dc1 or Dc2 shown in FIG. 9 (step S11 in FIG. 10). Next, the light amount balance control section 121 calculates a differential value (Dc−Dt) between the present A/D value (for example, the A/D value Dc1 or Dc2 in FIG. 9) of each lighting section 4 and a target A/D value (for example, a target A/D value Dt in FIG. 9), and determines whether or not the differential value is a value equal to or larger than 0 (step S12).

Then, in the lighting section 4 having a differential value (Dc−Dt) equal to or larger than 0 (step S12: Y, for example, in the case of (Dc1−Dt) in FIG. 9), the light amount balance control section 121 calculates a current magnitude ΔI (for example, a current magnitude ΔI1 in FIG. 9) based on the absolute value (for example, |Dc1−Dt|) of the differential value in the lighting section 4, the light emission characteristics (for example, LED characteristics G1) in the lighting section 4 and a predetermined factor (step 13), and reduces the light emission current in the lighting section 4 by the current magnitude ΔI (for example, reduces from the light emission current I0 to the light emission current I1) (step S14). In addition, a factor in a formula (1) is a correction factor in consideration of an initial current value and an initial A/D value in a formula (2), measurement variation in the A/D values Dc and Dt in the formula (1), the case where the LED characteristics G1, G2 or the like in FIG. 9 are nonlinear, and the like.

ΔI=(LED characteristic value)×|Dc1−Dt|×factor (a value ranging from 0 to 1) (1)

LED characteristic value=(initial current value)/(initial A/D value) (2)

On the other hand, in the lighting section 4 having a differential value (Dc−Dt) smaller than 0 (step S12: N, for example, in the case of (Dc2−Dt) in FIG. 9), the light amount balance control section 121 calculates the current magnitude ΔI (for example, a current magnitude ΔI2) based on the absolute value (for example, |Dc2−Dt|) of the differential value in the lighting section 4 and the light emission characteristics (for example, LED characteristics G2) in the lighting section 4 through the use of the above-described formula (1) in the same manner (step S15), and increases the light emission current in the lighting section 4 by the current magnitude ΔI (for example, increases from the light emission current I0 to the light emission current I2) (step S16).

Thereby, for example, as shown in FIG. 9, the A/D values of the light sensor in the lighting sections 4 having different light emission characteristics (for example, the lighting sections shown by the LED characteristics G1 and G2 in FIG. 9) are controlled into a same level (become the target A/D value Dt). Therefore, even if variation among the lighting sections 4 occurs, variation in the light emission intensity among the lighting sections 4 is reduced.

As described above, in the embodiment, the light emission currents IR, IG and IB in each lighting section 4 are adjusted by the light amount balance control section 121 in consideration of variation in light emission characteristics (for example, LED characteristics G1 and G2) showing a relationship between the light emission currents IR, IG and IB in an illuminating lighting section 4 and the detected light amount (the A/D value of the light sensor) for the corresponding lighting section 4, thereby the light emission intensity of each lighting section 4 is controlled, so even in the case where variation among the lighting sections 4 occurs, variation in light emission intensity among the lighting sections 4 is able to be reduced. Therefore, in the case where partial lighting operation is performed, variation in characteristics among the lighting sections is able to be reduced.

More specifically, the light emission intensities of the lighting sections 4 are controlled into a same level by adjusting the light emission currents IR, IG and IB in each lighting section 4, so the above-described effects are able to be obtained.

Moreover, such a backlight system 1 is used as a backlight (a light source device for liquid crystal) of the liquid crystal display 3, so unevenness in luminance, color or the like is able to be reduced in the whole liquid crystal display 3.

In addition, in the embodiment, for example, as shown by arrows P1 and P2 in FIG. 9, the light emission intensity of each lighting section 4 may be controlled by adjusting the light emission currents IR, IG and IB also in consideration of a change in the LED characteristics G1 and G2 in the lighting sections 4 with a lapse of time. More specifically, for example, the current magnitude ΔI may be calculated by multiplying the right side of the above-described formula (1) by a predetermined correction factor showing a change with a lapse of time. In such a configuration, compared to the embodiment, variation in characteristics among the lighting sections 4 is able to be further reduced.

Although the present invention is described referring to the embodiment, the invention is not limited to the embodiment, and may be variously modified.

Moreover, in the above-described embodiment, the case where four lighting sections 4 are arranged in one detection region 40 is described; however, the number of the lighting sections 4 is not limited to four. Further, in the above-described embodiment, the case where all of four lighting sections 4 illuminate in the whole lighting duration Δt4, and only one lighting section 4 illuminates in a partial lighting duration Δt1 is described; however, the invention is not limited to the case, and it is only necessary for the number of lighting sections illuminating in the whole lighting duration to be larger than the number of the lighting sections 4 illuminating in the partial lighting duration.

Further, in the above-described embodiment, the case where the luminance and the color temperature of the light source is controlled by changing at least light emission intensity of each LED is described; however, at least one of the luminance and the color temperature of the light source may be controlled by changing at least one of duration of lighting and light emission intensity of each LED.

In the above-described embodiment, the case where the red LED 1R, the green LED 1G and the blue LED 1B are contained in separate packages is described; however, for example, LEDs of a plurality of colors may be contained in one package.

In the above-described embodiment, the case where the illumination light sensor 13 includes light sensors of three colors, that is, the red light sensor 13R, the green light sensor 13G and the blue light sensor 13B is described; however, for example, the illumination light sensor 13 may include only one light sensor, and the light source 10 may time-sequentially turn on the red LED 1R, the green LED 1G and the blue LED 1B, thereby the illumination light Lout may be detected.

In the above-described embodiment, the case where the light source 10 includes the red LED 1R, the green LED 1G and the blue LED 1B is described; however, in addition to them (or instead of them), the light source 10 may include an LED emitting another color light. In the case where light of four or more colors is used, a color reproduction range can be expanded, and more various colors can be displayed.

In the above-described embodiment, the case where the light source 10 includes an LED is described; however, the light source 10 may include any other self-luminous device (such as an EL device or a laser device).

In the above-described embodiment, the case where the liquid crystal display 3 is a transmissive liquid crystal display including the backlight system 1 is described; however, the light source device according to the embodiment of the invention may be used as a front light system to form a reflective liquid crystal display.

In the above-described embodiment, the liquid crystal display panel is described as an example of the display section; however, as the display section, any panel other than the liquid crystal display panel may be used.

For example, the light source device according to the embodiment of the invention is applicable to not only the light source device for liquid crystal display but also any other light source device such as an illumination device.

It should be understood by those skilled in the art that various modifications, combinations, sub-combinations and alterations may occur depending on design requirements and other factors insofar as they are within the scope of the appended claims or the equivalents thereof.

What is claimed is:

1. A light source system comprising:
a light source having a plurality of lighting sections each including one or more light-emitting diodes and being controllable independently of one another;
a light-sensing device detecting light from the light source in which the lighting sections are allowed to illuminate independently of one another; and
a light source control means for controlling the light source by changing at least light emission intensity of each lighting section on the basis of a light amount detected by the light-sensing device for each lighting section,
wherein the light source control means adjusts light emission currents in each lighting section in consideration of variation, among the plurality of lighting sections, in light emission characteristics showing a relationship between light emission currents flowing through the light-emitting diodes in a lighting section that illuminates and the light amount detected by the light-sensing device for the corresponding lighting section, thereby the light source control means controls the light emission intensity of each lighting section.

2. The light source system according to claim 1, wherein
the light source control means controls the light emission intensities of the lighting sections into a same level by adjusting a light emission current in each of the lighting sections.

3. The light source system according to claim 2, wherein
the light source control means reduces a light emission current in a lighting section in which the present detected light amount value detected by the light-sensing device is larger than a target value, and
the light source control means increases a light emission current in a lighting section in which the present detected light amount value detected by the light-sensing device is smaller than the target value.

4. The light source system according to claim 3, wherein
the light source control means reduces, by a current magnitude, a light emission current in a lighting section in which the present light amount value detected by the light-sensing device is larger than the target value, the current magnitude calculated based on the light emission characteristics in the corresponding lighting section and a differential value between the present detected light amount value and the target value,
the light source control means increases, by a current magnitude, a light emission current in a lighting section in which the present light amount value detected by the light-sensing device is smaller than the target value, the current magnitude calculated based on the light emission characteristics in the corresponding lighting section and a differential value between the present detected light amount and the target value and.

5. The light source system according to claim 1, wherein
the light source control means controls the light emission intensity of each lighting section by adjusting a light emission current in consideration of a change, in the light emission characteristics in each lighting section, with a lapse of time.

6. The light source system according to claim 1, wherein
the light source control means controls at least one of the luminance and the color temperature of each lighting section by changing at least one of duration of lighting and light emission intensity of each lighting section.

7. A display comprising:
a light source system; and
a display section modulating light emitted from the light source system on the basis of an image signal,
wherein the light source system includes:
a light source having a plurality of lighting sections each including one or more light-emitting diodes and being controllable independently of one another;
a light-sensing device detecting light from the light source in which the lighting sections are allowed to illuminate independently of one another; and
a light source control means for controlling the light source by changing at least light emission intensity of each lighting section on the basis of a light amount detected by the light-sensing device for each lighting section,
wherein the light source control means adjusts light emission currents in each lighting section in consideration of variation, among the plurality of lighting sections, in light emission characteristics showing a relationship between light emission currents flowing through the light-emitting diodes in a lighting section that illuminates and the light amount detected by the light-sensing device for the corresponding lighting section, thereby the light source control means controls the light emission intensity of each lighting section.

8. A light source system comprising:
a light source having a plurality of lighting sections each including one or more light-emitting diodes and being controllable independently of one another;
a light-sensing device detecting light from the light source in which the lighting sections are allowed to illuminate independently of one another; and
a light source control section controlling the light source by changing at least light emission intensity of each lighting section on the basis of a light amount detected by the light-sensing device for each lighting section,
wherein the light source control section adjusts light emission currents in each lighting section in consideration of variation, among the plurality of lighting sections, in light emission characteristics showing a relationship between light emission currents flowing through the light-emitting diodes in a lighting section that illuminates and the light amount detected by the light-sensing device for the corresponding lighting section, thereby the light source control section controls the light emission intensity of each lighting section.
